(19) United States
(12) Patent Application Publication
(10) Pub. No.: US 2025/0285007 A1
(43) Pub. Date: Sep. 11, 2025

(54) METHOD AND SYSTEM FOR AUTOMATIC RETRAINING OF MACHINE LEARNING MODELS FOR METROLOGY METRIC ESTIMATION

(71) Applicant: KLA Corporation, Milpitas, CA (US)

(72) Inventors: Sveta Grechin, Milpitas, CA (US); Udi Shusterman, Milpitas, CA (US); Boaz Ophir, Milpitas, CA (US)

(21) Appl. No.: 18/597,581

(22) Filed: Mar. 6, 2024

(51) Int. Cl. G06N 20/00

(52) U.S. Cl. CPC G06N 20/00

(57) ABSTRACT

A metrology method with automated triggering of retraining of a machine learning model (MLM) is disclosed. The method may acquire metrology measurement data from a plurality of sites of a wafer. The method may apply a MLM to the measurement data to predict a metrology metric. The method may apply a triggering algorithm to monitor the effectiveness of the MLM, wherein the triggering algorithm determines a dissimilarity between the measurement data and a training data set of the MLM. The triggering algorithm may identify a failed MLM state when the distance between the measurement data and the training data set exceeds one or more thresholds. The method may retrain the MLM using an adjusted training data set. The adjusted training data set may be generated by adding the measurement data from the wafer to the training data set. The method may apply the retrained MLM to a subsequent wafer.

### TECHNICAL FIELD

The present disclosure generally relates to the use of machine learning models in semiconductor metrology, and, more particularly, to the automatic triggering of retraining of machine learning models.

### BACKGROUND

Machine learning (ML) models are often used to improve metrology accuracy during monitoring of semiconductor fabrication processes. ML models are sensitive to complex process variations and many measurement tool states. Such variations can change the measurement distribution of wafers and deteriorate the prediction accuracy and reliability of the ML model over time.

To mitigate the decrease in accuracy of ML models over time, previous approaches implemented manual retraining of ML models when the model predictions are deemed to be unsatisfactory. In this case, the user manually invalidates the model and start from scratch to retrain the ML with new training data. Manual retraining approaches require constant supervision and is costly in terms of both human and tool time. An additional approach to maintaining ML model prediction quality involves time-based triggering of ML retraining. In a time-based approach, data collection occurs at periodic intervals and the ML model is retrained after each data collection cycle. If properly configured, time-based periodic triggering can track and adapt to slowly varying process/tool shifts. However, periodic triggering can be needlessly costly as it may initiate data collection and ML model retraining even when it is not needed. In addition, time-based periodic triggering may miss flier wafers, causing these wafers to go through undetected even though model predictions for them are not valid.

Therefore, it is desirable to provide a method and system for ML model monitoring in metrology systems that overcome the shortcomings described above.

### SUMMARY

A metrology method with automated machine learning model retraining is disclosed. In some aspects, the method includes acquiring metrology measurement data from a plurality of sites of a wafer; applying a machine learning model to the measurement data acquired from the wafer to provide a prediction output of one or more metrology metrics for the wafer based on the measurement data from plurality of sites of the wafer, wherein the machine learning model is trained using a training data set; applying a triggering algorithm to monitor effectiveness of the machine learning model, wherein the triggering algorithm performs two or more distance calculations to determine a distance between the measurement data and the training data set, wherein the two or more distance calculations comprise applying a statistical distance analysis technique to determine a first distance calculation between the measurement data and the training data set and applying a machine learning algorithm to determine a distance between the measurement data and the training data set; identifying, with the triggering algorithm, a failed machine learning model state when the first distance exceeds a first threshold or the second distance exceeds a second threshold; retraining the machine learning model using an adjusted training data set to generate a retrained machine learning model, wherein the adjusted training data set is generated by adding the measurement data from the wafer to the training data set; and applying the retrained machine learning model to a second wafer to provide a prediction output of one or more metrology metrics for the second measured wafer.

A metrology system equipped with automated machine learning model retraining is disclosed. In some aspects, the metrology system includes a metrology sub-system; and a controller communicatively coupled to the metrology sub-system, the controller including one or more processors and memory, wherein the one or more processors are configured to execute a set of program instructions stored on the memory, the program instructions configured to cause the one or more processors to: acquire metrology measurement data from a plurality of sites of a wafer via the metrology sub-system; apply a machine learning model to the measurement data acquired from the wafer to provide a prediction output of one or more metrology metrics for the wafer based on the measurement data from plurality of sites of the wafer, wherein the machine learning model is trained using a training data set; apply a triggering algorithm to monitor effectiveness of the machine learning model, wherein the triggering algorithm performs two or more distance calculations to determine a distance between the measurement data and the training data set, wherein the two or more distance calculations comprise applying a statistical distance analysis technique to determine a first distance calculation between the measurement data and the training data set and applying a machine learning algorithm to determine a distance between the measurement data and the training data set; identify, with the triggering algorithm, a failed machine learning model state when the first distance exceeds a first threshold or the second distance exceeds a second threshold; retrain the machine learning model using an adjusted training data set to generate a retrained machine learning model, wherein the adjusted training data set is generated by adding the measurement data from the wafer to the training data set; and apply the retrained machine learning model to a second wafer to provide a prediction output of one or more metrology metrics for the second measured wafer.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures.

FIG. 1 illustrates a block diagram view of a metrology system equipped with automatic machine learning model retraining capabilities, in accordance with one or more embodiments of the present disclosure.

FIG. 2 illustrates a data graph depicting a comparison of metrology measurement data obtained from a semiconductor wafer and training data used to train a machine learning model for analyzing metrology metrics of the wafer, in accordance with one or more embodiments of the present disclosure.

FIG. 3 illustrates a distance plot map depicting training observations, a learned frontier, new regular observations, and new abnormal observations obtained from sites of a semiconductor wafer, in accordance with one or more embodiments of the present disclosure.

FIG. 4 illustrates a process flow diagram depicting a method of automatic triggering of a retaining of a machine learning model, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

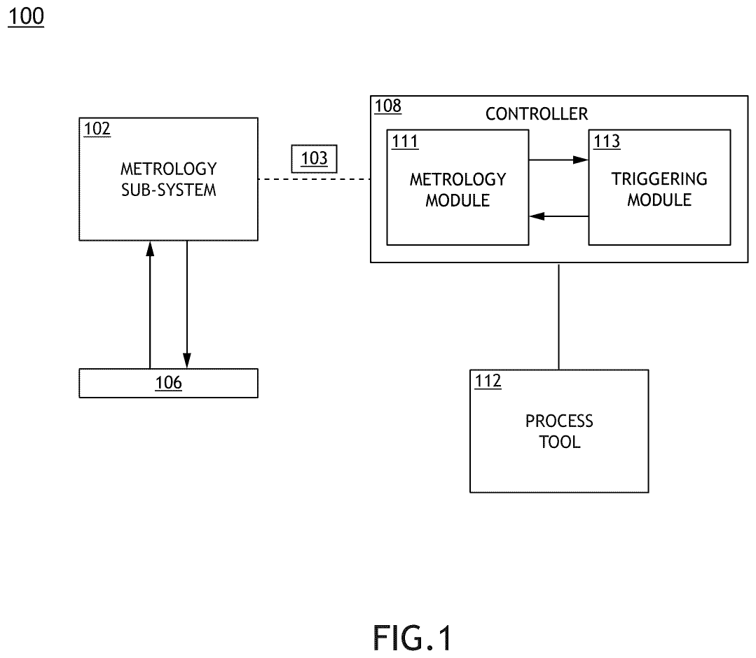

Referring generally to FIGS. 1-4, a system and method for automatic retraining of a machine learning model used in metrology metric estimation is described, in accordance with one or more embodiments of the present disclosure.

Embodiments of the present disclosure are directed to an automatic ML model retrain triggering mechanism to monitor and adaptively update an ML model being used to improve metrology accuracy. Embodiments of the present disclosure incorporate statistical and unsupervised ML algorithms which automatically detect shifts in measurement distributions, and initiate data collection to continuously adjust the ML model in the event of process variations and variations in metrology tool states. The proposed mechanism does not require periodic retraining but rather initiates data collection and model updates only when required.

The ML model retraining triggering methodology of the present disclosure may adaptively choose for training only those wafers which possess novel information, thus reducing the number of wafers required for initial training and time to model. The main advantage of the ML retrain triggering methodology of the present disclosure is that training data collection and ML model retraining only take place when confidence in the ML model is low (i.e., statistics of the measured wafer strongly differ from the training set). This intelligent approach to determining when to retrain the ML model saves metrology tool time, thereby improving the throughput of the metrology tool.

The ML model retrain triggering methodology may detect flier wafers (i.e., wafers that for some reason are very different from the expected norm). In previous methods, these events would be false negatives and be missed by the ML model. The ML model retrain triggering methodology of the present disclosure adds a layer of defense against such faulty wafers.

The retraining triggering methodology of the present disclosure may be implemented to monitor and automatically retrain ML models used to improve various metrology measurements such as, but not limited to, modeled tool-induced shift (mTIS) measurements. A discussion of mTIS measurements and the implementation of a corresponding machine learning algorithm is described in U.S. Pat. No. 11,410,290, issued on Aug. 9, 2022, which is incorporated herein by reference in the entirety.

FIG. 1 illustrates a block diagram view of a metrology system 100 implementing automated machine learning model retraining, in accordance with one or more embodiments of the present disclosure. In embodiments, the system 100 includes a metrology sub-system 102 for acquiring metrology measurements from a semiconductor wafer 106 (e.g., 3D NAND wafer). In embodiments, the system 100 includes a controller 108. The controller 108 may include one or more processors configured to execute program instructions stored in memory. The controller 108 may be configured to execute a metrology module 111 and a triggering evaluation module 113.

In embodiments, the metrology module 111 may be configured to cause the controller 108 to apply a machine learning model to measurement data 103 acquired from the measured wafer 106 with the metrology sub-system 102. The machine learning model may provide estimations of one or more metrology metrics (e.g., estimation model of the one or more metrology metrics) for the measured wafer 106. An estimation model may be configured to provide estimations of one or more metrology metrics with respect to measurement data of sites on the measured wafer. The machine learning model applied via the metrology module 111 may be trained using a training data set. The training data set may include raw data acquired from a set of sites of one or more training wafers. The training data may be calculated by the system 100 from initial metrology measurements and relate to multiple sites across multiple fields on the one or more training wafers. For example, in the case of TIS measurements, the calculation of training data may include using pairs of images (e.g., first image and 180 degrees rotated image) derived from sites on a training wafer. The training data may include one or more processed features which are derived from each pair of images. In embodiments, the machine learning model may include one or more of Principal Component Regression, Support Vector Machines, Gradient Boosting and/or Neural Networks algorithms. The machine learning model may be embodied within a metrology module 111 executed by the one or more processors of controller 108. Machine learning and training data applied in the context of metrology measurements is described in greater detail in U.S. Pat. No. 11,410,290 incorporated previously herein.

In embodiments, the controller 108 applies a triggering algorithm of a triggering module 113 to monitor the effectiveness of the machine learning model. The triggering algorithm may determine a dissimilarity between the measurement data 103 from the wafer 106 and the training data set.

In embodiments, the triggering evaluation module 113 may be configured to cause the controller 108 to execute the triggering algorithm to monitor the effectiveness of the machine learning model of the metrology module 111. The triggering algorithm of the triggering evaluation module 113 may monitor the effectiveness of the machine learning module by determining a difference, or statistical distance, between the measurement data acquired from the wafer and the training data set for the current iteration of the machine learning model. In embodiments, the triggering algorithm, when executed, identifies a failed state of the machine learning model when the difference between the measurement data from the wafer 106 and the training data exceeds one or more selected thresholds or threshold analysis. In this sense, the controller 108 may quantify a similarity between the measurement data 103 and the training data. A large difference between the measurement data 103 and the training data indicates that the current iteration of the ML model is inadequate for providing quality estimations of the one or more metrology metrics for the wafer 106. A difference between the measurement data and the training data exceeding the one or more selected thresholds (i.e., confidence of the effectiveness of the machine learning model is unacceptable) may indicate excessive process variation and/or excessive variations in metrology tool states.

The triggering algorithm may include applying two or more distance calculation techniques to determine a distance, or dissimilarity, between the measurement data and the training data set. In this regard, in the context of the present disclosure, ‘distance’ may be interpreted as a distance between distributions or a distance between a point and a distribution. For example, the triggering algorithm may include applying i) a statistical distance analysis technique; and ii) one or more ML algorithms to quantify the dissimilarity between the measured data from wafer 106 and the initial training data set. For instance, the triggering evaluation module 113 may execute the triggering algorithm that includes determining a first distance between the measurement data and the training data set using a statistical analysis technique and a second distance between the measurement data and the training data set using a machine learning technique. Then, in order to identify whether the machine learning model (of the metrology module 111) should be failed, the triggering algorithm of the triggering evaluation module 113 may compare the first distance to a first selected threshold and the second distance to a second selected threshold. In this embodiment, in the event the first distance is greater than the first threshold or the second distance is greater than the second threshold, the triggering algorithm may identify the current iteration of the ML model of the metrology module 111 as inadequate for providing quality estimations of the one or more metrology metrics for the wafer 106 with the current measurement data. In this regard, the triggering algorithm may utilize distance between the measurement data from the wafer 106 and the training data set, whereby the distance indicates the dissimilarity between the current wafer measurement observation and the training data set wafer.

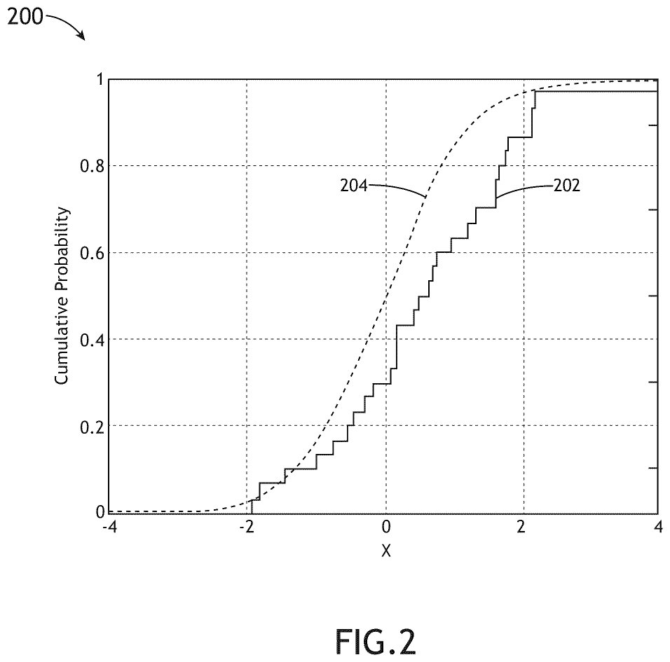

For example, as shown in FIG. 2, the difference, or statistical distance, between the measurement data from wafer 106 and the trained data set may be embodied as a difference between the cumulative probability of metric values from the measurement data distribution 202 and the training data distribution 204. In this sense, when the dissimilarity of the measurement data distribution 202 from the training data distribution 204 is large enough, the triggering algorithm identifies the current ML model being unfit for analyzing the current wafer 106.

By way of example, the triggering module 113 may calculate a distance between the measurement data and the training data set using two techniques including i) a statistical distance calculation via a Mahalanobis analysis and a Kolmogorov-Smirnov (KS) test; and ii) a distance determination via a machine learning algorithm (e.g., one-class support vector machine). In this example, each technique may have its own selected threshold or threshold analysis. In embodiments, the threshold values for each technique may be defined in a way that triggering occurs when more than 50% of the measurement data does not overlap with the training data set. It is noted that the thresholds values applied to each technique may be adjusted based on user input and required failure rates. Therefore, the 50% threshold should not be interpreted as a limitation on the present disclosure and is provided only for purposes of illustration. Moreover, the threshold value may be different for each technique.

After applying the thresholds to each technique, the triggering algorithm may output a Boolean result of 0 or 1 for each distance calculation technique. In this example, a result of ‘1’ signifies that the measurement wafer is outside the training dataset distribution. In this case, the measured data for the wafer may be added to the training dataset and the subsequent model is retrained. A result of ‘0’ signifies that the measurement wafer is within the training distribution. Thus, in this example, there are four possible Boolean combinations for the two distance techniques: 00, 11, 10, 01. In embodiments, a final trigger decision at the wafer level is carried out by applying a logic OR operation on the Boolean results. In this manner, if any of the distances described above indicate that a wafer is outside the training distribution, the model should be retained. The following provides a detailed explanation of the triggering algorithm.

In a first step, a statistical distance calculation may be performed. For example, the statistical distance calculation may include applying a Mahalanobis distance analysis (or an equivalent analysis). In doing so, the Mahalanobis distance may be calculated for each site on training wafer as follows:

$${D}_{Mahalanobis\_train} = \sqrt{{( {x}_{train} - {μ}_{train} )}^{t} \cdot {Cov ( {x}_{train} )}^{- 1} \cdot ( {x}_{train} - {μ}_{train} )}$$

where:
μₜᵣₐᵢₙ is training dataset mean value
Cov(xₜᵣₐᵢₙ)⁻¹ is training dataset covariance matrix
xₜᵣₐᵢₙ is training wafer features matrix

Then, the Mahalanobis distance may be calculated for each site on the measurement (or test) wafer as follows:

$${D}_{Mahalanobis\_test} = \sqrt{{( {x}_{test} - {μ}_{train} )}^{t} \cdot {Cov ( {x}_{train} )}^{- 1} \cdot ( {x}_{test} - {μ}_{train} )}$$

where:
μₜᵣₐᵢₙ is training dataset mean value
Cov(xₜᵣₐᵢₙ)⁻¹ is training dataset covariance matrix
xₜₑₛₜ is measurement wafer features matrix

Then, the Kolmogorov-Smirnov (KS) test may report the maximum difference between the two cumulative distributions of D_{Mahalanobis}: train and test. Using a KS test statistic value, the triggering algorithm generates a grade in the range: [0:1]. This value describes dissimilarity between training and measurement datasets.

$$Stat = {max}_{x} \vert CDF ( {D}_{Mahalanobis\_train} ) - CDF ( {D}_{Mahalanobis\_test} ) \vert$$

where:
CDF is cumulative distribution function

In this example, the output range spans from 0 to 1, enabling straightforward comprehension of the threshold value logic. The selected threshold may be set at any level. For example, the selected threshold may be set to 0.5. In this example, a grade less than 0.5 indicates that more than 50% of measurement data is not overlapping with training dataset, while a grade greater than 0.5 indicates that more than 50% of measurement data is overlapping with training dataset.

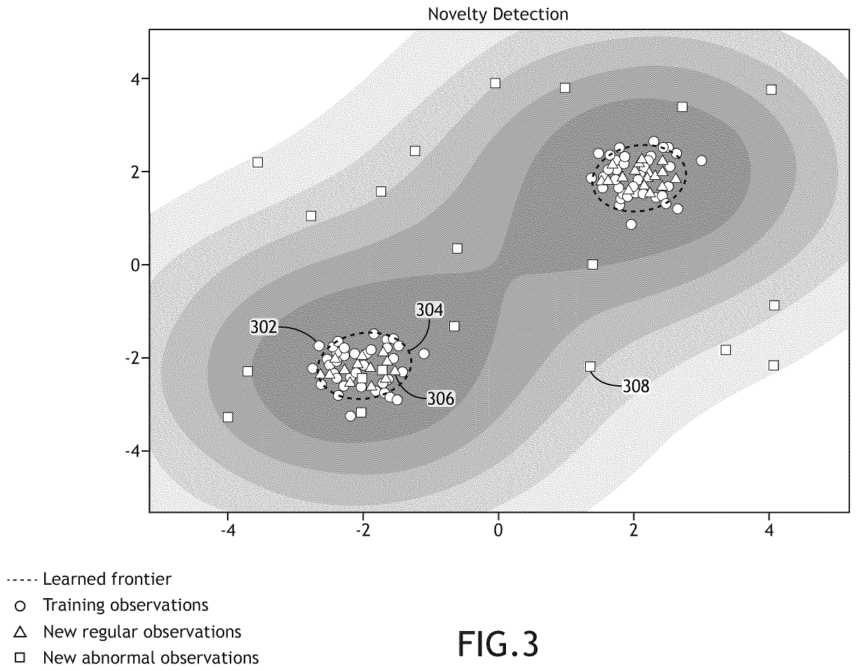

In a second step, a machine learning algorithm is performed to determine a distance between the measurement data and the training data set. For example, a one-class unsupervised machine learning algorithm may be executed to determine a distance between the measurement data and training data set. The one-class unsupervised machine learning algorithm may include, but is not limited to, a one-class support vector machine (SVM). In this example, distance is the prediction from the one-class SVM model on a specific observation/site of the wafer. Predictions which are outside of a learned frontier will be negative and those predictions within the learned frontier are deemed positive. A more positive value indicates a shorter distance to the training set, while more negative values signify a larger distance to the training set. The behavior is illustrated conceptually in FIG. 3. As shown, the data sets include training observations 302, a learned frontier 304, new regular observations 306, and new abnormal observations 308.

Then, a trigger decision at the wafer level may be made using one of two approaches. In a first example, if the mean value of the predictions on all wafer sites is positive, the triggering algorithm indicates that the measurement wafer is within the train distribution. In a second example, if the percentage of the positive predictions out all sites is greater than a selected threshold (e.g., 50%) the measurement wafer is identified as being within distribution.

In the case where the measurement data from the wafer 106 fails the threshold analysis for either the i) statistical distance analysis; or ii) the machine learning approach to distance analysis, the triggering algorithm identifies that the machine learning model of the triggering module 113 is in a failed state and is inadequate for providing metrology predictions given the current measurement data.

In embodiments, the controller 108 may adjust the machine learning model of the metrology module 111 when the difference between the measurement data and the training data exceeds the first or second thresholds. The controller 108 may adjust the machine learning model by adding the measurement data from the measured wafer 106 to the training data set and retraining the machine learning model to generate a retrained machine learning model. The updated training data set and the retrained machine learning model may be stored in memory of the controller 108 and/or made accessible by the controller 108 via a network connection.

In embodiments, the controller 108 applies the retrained machine learning model to a subsequent measured wafer to provide estimations of one or more metrology metrics for the subsequent measured wafer. In turn, the triggering evaluation process may be repeated for subsequent wafers, whereby the training data set is updated, and the ML model is retrained, each time the triggering algorithm fails a given wafer.

The one or more processors of the controller 108 may include any one or more processing elements known in the art. In this sense, the one or more processors may include any microprocessor-type device configured to execute software algorithms and/or instructions. In one embodiment, the one or more processors may consist of a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium. Moreover, different subsystems of the various systems disclosed may include processor or logic elements suitable for carrying out at least a portion of the steps described throughout the present disclosure. Therefore, the above description should not be interpreted as a limitation on the present disclosure but merely an illustration.

The memory of controller 108 may include any storage medium known in the art suitable for storing program instructions executable by the associated one or more processors. For example, the memory medium may include a non-transitory memory medium. For instance, the memory medium may include, but is not limited to, a read-only memory, a random-access memory, a magnetic or optical memory device (e.g., disk), a magnetic tape, a solid-state drive, and the like. In another embodiment, the memory is configured to store one or more results and/or outputs of the various steps described herein. It is further noted that memory may be housed in a common controller housing with the one or more processors. In an alternative embodiment, the memory may be located remotely with respect to the physical location of the processors. For instance, the one or more processors may access a remote memory (e.g., server), accessible through a network (e.g., internet, intranet, and the like). In another embodiment, memory medium maintains program instructions for causing the one or more processors to carry out the various steps described through the present disclosure.

The system 100 may include one or more process tools 112 (e.g., lithography tool or the like). The controller 108 may provide feedback to upstream process tools and/or feedforward to downstream process tools to adjustment one or more characteristics of the one or more process tools. The adjustments may be based on the estimations from the current ML model (when the model passes the triggering algorithm) or on a retrained ML model (when the model fails the triggering algorithm and is retrained.

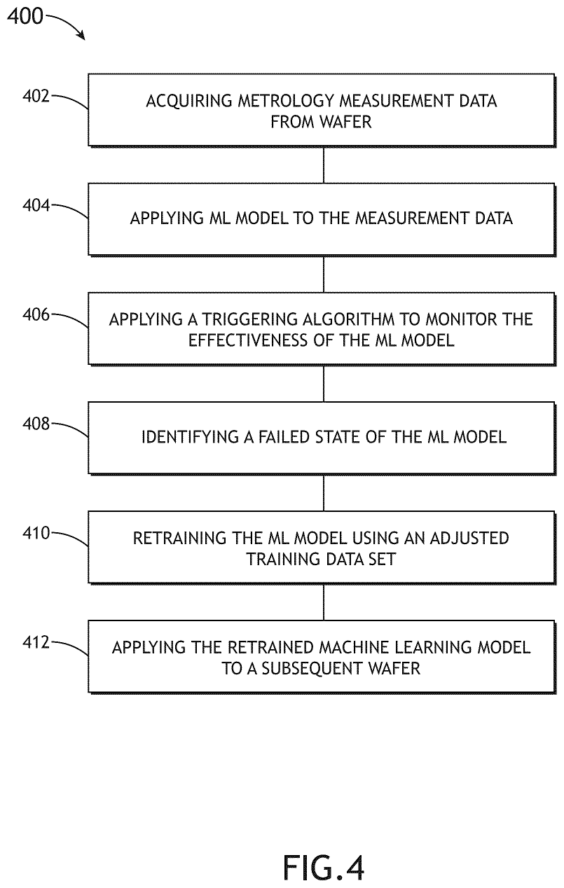

FIG. 4 illustrates a process flow diagram of a method 400 of automated triggering of machine learning model retraining for metrology metric estimation, in accordance with one or more embodiments of the present disclosure. It is noted herein that the steps of method 300 may be implemented all or in part by the metrology system 100. It is further recognized, however, that the method 400 is not limited to the metrology system 100 in that additional or alternative system-level embodiments may carry out all or part of the steps of method 400.

In step 402, the method includes acquiring metrology measurement data from a plurality of sites of a wafer. For example, as shown in FIG. 1, the metrology sub-system 102 may acquire measurement data 103 from sites of the wafer 106. In turn, this raw measurement data 103 may be transmitted to controller 108. The metrology measurement data may include any type of metrology measurement data used to monitor semiconductor device fabrication processes. For example, the measurement data may include, but is not limited to, TIS data.

In step 404, the method includes applying a machine learning model to the measurement data. In embodiments, the method includes applying a machine learning model to the measurement data acquired from the wafer to provide a prediction output of one or more metrology metrics for the wafer based on the measurement data from plurality of sites of the wafer. The machine learning model may be trained using an initial training data set. For example, in the case of TIS data, the metrology sub-system 102 may acquire TIS data (e.g., raw TIS data or pre-processed TIS data) from the wafer 106. In turn, the controller 108 may apply the trained ML model of the metrology module 111 to the TIS data to generate a prediction output containing a prediction for one or more metrology metrics.

In step 406, the method includes applying a triggering algorithm to monitor effectiveness of the machine learning model. In embodiments, the triggering algorithm determines a difference between the measurement data and the training data set. For example, as shown in FIG. 1, the triggering evaluation module 113 may execute the triggering algorithm to monitor the effectiveness of the machine learning module. For example, the method may include executing a triggering algorithm that includes a combination of i) statistical distance analysis; and ii) one or more ML algorithms to determine distance. In embodiments, the triggering algorithm may perform the statistical distance analysis using a combination of a Mahalanobis distance analysis and a Kolmogorov-Smirnov test. In embodiments, the triggering algorithm may perform the one or more ML algorithms to determine distance using a one-class unsupervised ML algorithm to determine distance. It is noted that step 406 may be performed prior to step 404 in any particular iteration such that the triggering determination is performed prior to providing metrology metric estimations via the ML model of step 404.

In step 408, the method includes identifying a failed machine learning model state. In embodiments, the triggering algorithm, when either the statistical distance analysis of step 406 exceeds a selected threshold or threshold analysis or the one or more distance-determining ML algorithms indicates an exceeded threshold or threshold analysis. When the dissimilarity of the measurement data distribution from the training data distribution is large enough, as characterized as the first threshold and second threshold being breeched, the triggering algorithm identifies the current ML model being unfit for analyzing the current wafer 106.

In step 410, the method includes retraining the ML model using an adjusted training data set. In embodiments, following identification of a failed state of the machine learning model (step 408), the adjusted training data set is generated by adding the measurement data from the current wafer 106 to the initial training data set. In this sense, the triggering algorithm identifies wafers containing novel information which departs from that which is expected from the initial training data. As a result of augmenting the initial training data set with the measurement data from the failed wafer, the adjusted training data set is enriched and becomes more useful for future predictions. In embodiments, when a wafer is failed by the triggering algorithm, the wafer in question may be measured in additional depth to create ground truth values for that wafer. These ground truth values may be reported to a user via the controller 108 rather than the ML predicted values which are reported for a passed wafer.

In step 312, the method includes applying the retrained machine learning model to a subsequent wafer to provide a prediction output of one or more metrology metrics for the subsequent measured wafer.

One skilled in the art will recognize that the herein described components, operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A metrology method comprising:
acquiring metrology measurement data from a plurality of sites of a wafer;
applying a machine learning model to the measurement data acquired from the wafer to provide a prediction output of one or more metrology metrics for the wafer based on the measurement data from plurality of sites of the wafer, wherein the machine learning model is trained using a training data set;
applying a triggering algorithm to monitor effectiveness of the machine learning model, wherein the triggering algorithm performs two or more distance calculations to determine a distance between the measurement data and the training data set, wherein the two or more distance calculations comprise applying a statistical distance analysis technique to determine a first distance calculation between the measurement data and the training data set and applying a machine learning algorithm to determine a second distance between the measurement data and the training data set;
identifying, with the triggering algorithm, a failed machine learning model state when the first distance exceeds a first threshold or the second distance exceeds a second threshold;
retraining the machine learning model using an adjusted training data set to generate a retrained machine learning model, wherein the adjusted training data set is generated by adding the measurement data from the wafer to the training data set; and
applying the retrained machine learning model to a second wafer to provide a prediction output of one or more metrology metrics for the second measured wafer.

2. The method of claim 1, wherein the statistical distance analysis of the triggering algorithm comprises applying a Mahalanobis distance analysis and a maximum difference analysis.

3. The method of claim 2, wherein the maximum distance analysis comprises a Kolmogorov-Smirnov test.

4. The method of claim 2, wherein the one or more machine learning algorithms of the triggering algorithm comprise one or more one-class unsupervised machine learning algorithms.

5. The method of claim 4, wherein the one or more one-class unsupervised machine learning algorithms comprise a one-class support vector machine.

6. The method of claim 4, wherein the one or more one-class unsupervised machine learning algorithms comprise a one-class support vector machine.

7. The method of claim 1, wherein the first threshold comprises a selected percentage of measurement data that does not overlap with the training data set.

8. The method of claim 1, wherein the first threshold comprises a selected percentage of measurement data that does not overlap with the training data set.

9. The method of claim 1, wherein the second threshold comprises: determining whether a mean value of predictions from the one or more machine learning algorithms on the measurement data from wafer sites is positive or negative, wherein a positive result indicates the measurement data is adequately similar to the training data set, wherein a negative result indicates the measurement data is inadequately dissimilar from the training data set.

10. The method of claim 1, wherein the second threshold comprises: determining whether a percentage of positive predictions from the one or more machine learning algorithms on the measurement data from wafer sites is greater than a selected percentage, wherein a percentage above the selected percentage indicates the measurement data is adequately similar to the training data set, wherein a percentage below the selected percentage indicates the measurement data is inadequately dissimilar from the training data set.

11. The method of claim 1, wherein the one or more metrics comprise tool induced shift (TIS).

12. The method of claim 1, wherein the wafer comprises a semiconductor wafer.

13. The method of claim 1, wherein the wafer comprises a 3D NAND wafer.

14. A system comprising:
a controller, the controller including one or more processors and memory, wherein the one or more processors are configured to execute a set of program instructions stored on the memory, the program instructions configured to cause the one or more processors to:
acquire metrology measurement data from a plurality of sites of a wafer;
apply a machine learning model to the measurement data acquired from the wafer to provide a prediction output of one or more metrology metrics for the wafer based on the measurement data from plurality of sites of the wafer, wherein the machine learning model is trained using a training data set;
apply a triggering algorithm to monitor effectiveness of the machine learning model, wherein the triggering algorithm performs two or more distance calculations to determine a distance between the measurement data and the training data set, wherein the two or more distance calculations comprise applying a statistical distance analysis technique to determine a first distance calculation between the measurement data and the training data set and applying a machine learning algorithm to determine a second distance between the measurement data and the training data set;
identify, with the triggering algorithm, a failed machine learning model state when the first distance exceeds a first threshold or the second distance exceeds a second threshold;
retrain the machine learning model using an adjusted training data set to generate a retrained machine learning model, wherein the adjusted training data set is generated by adding the measurement data from the wafer to the training data set; and
apply the retrained machine learning model to a second wafer to provide a prediction output of one or more metrology metrics for the second measured wafer.

15. The system of claim 14, wherein the statistical distance analysis of the triggering algorithm comprises applying a Mahalanobis distance analysis and a maximum difference analysis.

16. The system of claim 15, wherein the maximum distance analysis comprises a Kolmogorov-Smirnov test.

17. The system of claim 15, wherein the one or more machine learning algorithms of the triggering algorithm comprise one or more one-class unsupervised machine learning algorithms.

18. The system of claim 17, wherein the one or more one-class unsupervised machine learning algorithms comprise a one-class support vector machine.

19. The system of claim 17, wherein the one or more one-class unsupervised machine learning algorithms comprise a one-class support vector machine.

20. The system of claim 15, wherein the first threshold comprises a selected percentage of measurement data that does not overlap with the training data set.

21. The system of claim 15, wherein the first threshold comprises a selected percentage of measurement data that does not overlap with the training data set.

22. The system of claim 15, wherein the second threshold comprises: determining whether a mean value of predictions from the one or more machine learning algorithms on the measurement data from wafer sites is positive or negative, wherein a positive result indicates the measurement data is adequately similar to the training data set, wherein a negative result indicates the measurement data is inadequately dissimilar from the training data set.

23. The system of claim 15, wherein the second threshold comprises: determining whether a percentage of positive predictions from the one or more machine learning algorithms on the measurement data from wafer sites is greater than a selected percentage, wherein a percentage above the selected percentage indicates the measurement data is adequately similar to the training data set, wherein a percentage below the selected percentage indicates the measurement data is inadequately dissimilar from the training data set.

24. The system of claim 15, wherein the one or more metrics comprise tool induced shift (TIS).

25. The system of claim 15, wherein the wafer comprises a semiconductor wafer.

26. The system of claim 15, wherein the wafer comprises a 3D NAND wafer.

27. A metrology system comprising:
a metrology sub-system; and
a controller communicatively coupled to the metrology sub-system, the controller including one or more processors and memory, wherein the one or more processors are configured to execute a set of program instructions stored on the memory, the program instructions configured to cause the one or more processors to:
acquire metrology measurement data from a plurality of sites of a wafer via the metrology sub-system;
apply a machine learning model to the measurement data acquired from the wafer to provide a prediction output of one or more metrology metrics for the wafer based on the measurement data from plurality of sites of the wafer, wherein the machine learning model is trained using a training data set;
apply a triggering algorithm to monitor effectiveness of the machine learning model, wherein the triggering algorithm performs two or more distance calculations to determine a distance between the measurement data and the training data set, wherein the two or more distance calculations comprise applying a statistical distance analysis technique to determine a first distance calculation between the measurement data and the training data set and applying a machine learning algorithm to determine a second distance between the measurement data and the training data set;
identify, with the triggering algorithm, a failed machine learning model state when the first distance exceeds a first threshold or the second distance exceeds a second threshold;
retrain the machine learning model using an adjusted training data set to generate a retrained machine learning model, wherein the adjusted training data set is generated by adding the measurement data from the wafer to the training data set; and
apply the retrained machine learning model to a second wafer to provide a prediction output of one or more metrology metrics for the second measured wafer.

28. The system of claim 27, wherein the metrology sub-system is configured for tool-induced-shift measurements.
